(19) United States
(12) Patent Application Publication
(10) Pub. No.: US 2009/0104654 A1
(43) Pub. Date: Apr. 23, 2009

(54) LOW VOLATILITY HIGH TEMPERATURE TISSUE CONDITIONING CROSS-REFERENCE TO RELATED APPLICATION

(76) Inventors: Brian H. Kram, Tucson, AZ (US); Christopher Bieniarz, Tucson, AZ (US)

Correspondence Address: HAYES SOLOWAY P.C., 3450 E. SUNRISE DRIVE, SUITE 140, TUCSON, AZ, 85718, US

(21) Appl. No.: 11/720,705

(22) PCT Filed: Dec. 14, 2005
(86) PCT No.: PCT/US05/45498

§ 371 Date: Jun. 1, 2007

Related U.S. Application Data
(60) Provisional application No. 60/637,245, filed on Dec. 17, 2004.

(51) Int. Cl. G01N 1/30; G01N 1/31

(52) U.S. Cl. 435/40.5; 435/287.9

(57) ABSTRACT

Solutions exhibiting little or no evaporative loss at elevated temperatures, i.e., in excess of 100° C., are employed in place of conventional aqueous-based antigen retrieval solutions.

### CROSS-REFERENCE TO RELATED APPLICATION

This application claims priority from U.S. Provisional Application No. 60/637,245, filed Dec. 17, 2004.

### BACKGROUND OF THE INVENTION

1. Field of the Invention

The present invention relates to the processing of tissue samples, and more particularly to methods, materials, and apparatus for processing of embedded tissue samples. The invention will be described with particular reference to processing of embedded biological tissue samples for staining and will be described in connection with such utility, although other utilities are contemplated.

2. Summary of the Related Art

The diagnosis of disease based on the interpretation of tissue or cell samples taken from a diseased organism has expanded dramatically over the past few years. In addition to traditional histological staining techniques and immunohistochemical assays, in situ techniques such as in situ hybridization and in situ polymerase chain reaction are now used to help diagnose disease states in humans. Thus, there are a variety of techniques that can assess not only cell morphology, but also the presence of specific macromolecules within cells and tissues. Each of these techniques requires that sample cells or tissues undergo preparatory procedures that may include fixing the sample with chemicals such as an aldehyde (such as formaldehyde, glutaraldehyde), formalin substitutes, alcohol (such as ethanol, methanol, isopropanol) or embedding the sample in inert materials such as paraffin, celloidin, agars, polymers, resins, cryogenic media or a variety of plastic embedding media (such as epoxy resins and acrylics). Other sample tissue or cell preparations require physical manipulation such as freezing (frozen tissue section) or aspiration through a fine needle (fine needle aspiration (FNA)). Regardless of the tissue or cell sample or its method of preparation or preservation, the goal of the technologist is to obtain accurate, readable and reproducible results that permit the accurate interpretation of the data. One way to provide accurate, readable and reproducible data is to prepare the tissue or cells in a fashion that optimizes the results of the test regardless of the technique employed. In the case of immunohistochemistry and in situ techniques this means increasing the amount of signal obtained from the specific probe (e.g., antibody, DNA, RNA, etc.). In the case of histochemical staining it may mean increasing the intensity of the stain or increasing staining contrast.

Without preservation, tissue samples rapidly deteriorate such that their use in diagnostics is compromised shortly after removal from their host. In 1893, Ferdinand Blum discovered that formaldehyde could be used to preserve or fix tissue so that it could be used in histochemical procedures. The exact mechanisms by which formaldehyde acts in fixing tissues are not fully established, but are believed to involve cross-linking of reactive sites within the same protein and between different proteins via methylene bridges (Fox et al., J. Histochem. Cytochem. 33: 845-853 (1985)). Recent evidence suggests that calcium ions also may play a role (Morgan et al., J. Path. 174: 301-307 (1994)). These links cause changes in the quaternary and tertiary structures of proteins, but the primary and secondary structures appear to be preserved (Mason et al., J. Histochem. Cytochem. 39: 225-229 (1991)). The extent to which the cross-linking reaction occurs depends on conditions such as the concentration of formalin, pH, temperature and length of fixation (Fox et al., J. Histochem. Cytochem. 33: 845-853 (1985)). Some antigens, such as gastrin, somatostatin and α-1-antitrypsin, may be detected after formalin fixation, but for many antigens, such as intermediate filaments and leukocyte markers, immunodetection after formalin treatment is lost or markedly reduced (McNicol & Richmond, Histopathology 32: 97-103 (1998)). Loss of antigen immunoreactivity is most noticeable at antigen epitopes that are discontinuous, i.e., amino acid sequences where the formation of the epitope depends on the confluence of portions of the protein sequence that are not contiguous.

Antigen retrieval refers to the attempt to “undo” the structural changes that treatment of tissue with a cross-linking agent induces in the antigens resident within that tissue. Although there are several theories that attempt to describe the mechanism of antigen retrieval (e.g., loosening or breaking of crosslinkages formed by formalin fixation), it is clear that modification of protein structure by formalin is reversible under conditions such as high-temperature heating. It is also clear that several factors affect antigen retrieval: heating, pH, molarity and metal ions in solution (Shi et al., J. Histochem. Cytochem. 45: 327-343 (1997)).

Heating appears to be the most important factor for retrieval of antigens masked by formalin fixation Different heating methods have been described for antigen retrieval in IHC such as autoclaving (Pons et al, Appl. Immunohistochem. 3: 265-267 (1995); Bankfalvi et al., J. Path. 174: 223-228 (1994)); pressure cooking (Miller & Estran, Appl. Immunohistochem. 3: 190-193 (1995); Norton et al., J. Path. 173: 371-379 (1994)); water bath (Kawai et al., Path. Int. 44: 759-764 (1994)); microwaving plus plastic pressure cooking (U.S. Pat. No. 5,244,787; Pertschuk et al., J. Cell Biochem. 19(suppl.): 134-137 (1994)); and steam heating (Pasha et al., Lab. Invest. 72: 167A (1995); Taylor et al., CAP Today 9: 16-22 (1995)).

Many solutions and methods are used routinely for staining enhancements. These may include but are not limited to distilled water, EDTA, urea, Tris, glycine, saline and citrate buffer. Solutions containing a variety of detergents (ionic or non-ionic surfactants) may also facilitate staining enhancement under a wide range of temperatures (from ambient to in excess of 100° C.).

Tissues and cells are also embedded in a variety of inert media (paraffin, celloidin, OCT™, agar, plastics or acrylics etc.) to help preserve them for future analysis. Many of these inert materials are hydrophobic and the reagents used for histological and cytological applications are predominantly hydrophilic; therefore, the inert medium may need to be removed from the biological sample prior to testing. For example, paraffin embedded tissue sections are prepared for subsequent testing by removal of the paraffin from the tissue section by passing the slide through various organic solvents such as toluene, xylene, limonene or other suitable solvents. These organic solvents are very volatile causing a variety of problems including requiring special processing (e.g., deparaffinization is performed in ventilated hoods) and requires special waste disposal. The use of these organic solvents increases the cost of analysis and exposure risk associated with each tissue sample tested and has serious negative effects for the environment.

The several aforesaid prior art retrieval methods require the input of heat for a period of time under specific conditions. For example, immunohistochemical (IHC) primary antibody incubations can be 16 minutes or greater at 42° C.; tissue conditioning takes place ˜100-120° C. for several minutes or more; in-situ hybridizations take place at 47° C. or greater for 1 hour or more. As a consequence of these requirements, fluid retention/conservation is necessary in order to prevent inappropriate fluid loss. Various fluid retention schemes have been practiced in such applications. For example, pressure vessels may be used to attain ˜120° C. for tissue conditioning processes. Steaming vessels have also been used for the same application wherein the larger steaming container moderates the loss of fluid via evaporation from the overall system while retaining appropriate fluid contacting in the immediate slide(s) vicinity. Humidified incubation chambers along with specialized hybridization coverslip devices have been widely used for manual in situ hybridization, which operate by the same principle of moderating evaporative loss in the immediate vicinity of the slide(s). One third party manufacturer uses relatively large slide volumes (flooding) with a closeted chamber to mitigate against significant evaporative losses. Ventana Medical Systems, Inc., Tucson, Ariz., the assignee of the present application uses LIQUID COVERSLIP™ (which is a light oil substance used to prevent evaporation of aqueous solutions on the slide) (see, e.g., U.S. Pat. No. 5,552,087). The oil layer inhibits the evaporative loss of water by “sealing” the top surface of the aqueous solution. For near-boiling point processes, however, both the oil and aqueous components evaporate at significant rates. In such instances it is necessary to frequently refresh the surface fluids in order to avoid surface dry-out or solution concentration. However, as a consequence of addition of room temperature fluids to near-boiling temperature slide surfaces, slides become momentarily cooled and have to go through constant temperature set point recovery. Depending on how a particular tissue sample was fixed, antigen retrieval protocol length can be adjusted accordingly to optimize the staining result while minimizing processing time. While effective at antigen retrieval, LIQUID COVERSLIP™processes are relatively slow and are limited by the boiling point of the aqueous solution. LIQUID COVERSLIP™ processes also require the use of a secondary fluid phase (oil) which works less effectively as process temperatures approach 100° C. Further, slide heat up and cool down times can be significant. In addition, prior to antigen retrieval, the embedding paraffin wax requires removal processing that can take an additional ˜25 minutes impacting throughput.

All such prior art schemes entail system design complexities and/or limitations. 120° C. processing requires pressure vessel containment limiting easy integration with downstream IHC processing in a single platform, for example. Neither can ˜100° C. steam processing be readily integrated without significant design consideration for fluid retention. Microwave and sonication processing entail instrumentation complexities of their own where integration with downstream IHC and ISH processing is a significant challenge. As a general rule, higher temperatures challenge fluid retention schemes where evaporative losses are more significant.

Operating too close to the boiling point of the retrieval solution also causes what can be described as “fluidic instabilities”. Fluidic instabilities can manifest in a number of ways. First, solution may evaporate when operated at elevated temperature over prolonged periods of time. Solution may concentrate and potentially dry-out unless the surfaces of the treated areas are refreshed or otherwise appropriately controlled. Second, dissolved gases come out of solution as temperature rises for many liquid systems. Entrained gas bubbles can occlude exposure of the tissue to solution at affected spots leading to insufficient treatment and inconsistent staining results. Third, the solution may phase change from liquid to gas (boil) at hot spots. In addition to producing entrained gas bubbles, nucleating gas bubbles in or around tissue may cause morphological damage. For all these reasons, antigen retrieval processes involve various measures to mitigate against the fluidic instabilities typically encountered with high temperature aqueous solution processing.

High pressure chambers have been used to both prevent solution loss while allowing for superheating of aqueous solutions to ˜126° C. for accelerated processing. While such a process serves to provide retrieval in a matter of only a few minutes, substantial time is still consumed with sample loading, apparatus heat up, apparatus cool-down, and sample unloading. High pressure processing also can be dangerous if high pressure steam inadvertently is allowed to escape. Further, incorporation of a pressurized vessel into an automated integrated system providing reliable, cheap, simple, and small footprint processing is not pragmatic.

In another example, slides may be put into a steamer to antigen retrieve. The issues and difficulties are similar to those of the high pressure steamer. Because the process is performed at ˜100° C. rather than ˜126° C., it generally takes on the order of ˜½ hour instead of a few minutes to retrieve with this method in addition to (un)loading and heating equilibration time factors.

What is needed is a method, antigen retrieval chemistry, and apparatus that does not exhibit fluidic instabilities, antigen retrieves in only a few minutes, has minimal heat up and cool down phases, does not require complex instrumentation to manage fluidics or temperature control, does not consume large volumes of fluids, and does not require a separate time consuming de-waxing process.

### SUMMARY OF THE INVENTION

The present invention provides methods, materials and apparatus for antigen retrieval based on the use of solutions that exhibit little or no evaporative loss potential, i.e., solvents that exhibit little or essentially no vapor pressure at elevated temperatures, i.e., in excess of 100° C. More particularly, the present invention provides novel solution chemistries for antigen retrieval that are fluidically stable at elevated temperatures, exhibit little or essentially no vapor pressure, are effective at heating and cooling rapidly to set point temperatures, do not consume large volumes of fluids, are effective at antigen retrieval in only a few minutes, do not involve complex instrumentation, and that can be used without prior de-waxing of the tissue section.

Enabling the present invention is the use of low or essentially no vapor pressure liquid antigen retrieval chemistry in place of aqueous-based antigen retrieval chemistry.

Vapor pressure of a particular substance is a function of that substance and the temperature. As a general rule the higher the boiling point of a particular material, the lower its vapor pressure at any given temperature below boiling point. Particularly useful in the present invention are substances that are liquid at room temperature and have boiling points in excess of about 200° C. The substances preferably also have viscosities less than about 300 centipoise at anticipated operating temperatures of 100-160° C., and should be active in antigen retrieval. Various substances or materials are available commercially that satisfy the aforesaid criteria. One class of preferred materials that satisfy the aforesaid criteria are organic salts that normally are liquid at room temperature, also known as “ionic liquids”. Because they are salts, they do not volatilize; hence, they exhibit essentially no vapor pressure and do not boil, at least within the temperature range of interest between e.g., 100° C.-160° C. Another class of preferred materials meeting the aforesaid criteria are aminopolyols. Aminopolyols arc low vapor pressure high boiling point materials that include aminoglycols, i.e., aminopolyols displaying one amine and two hydroxyl groups attached to the carbon chain. Particularly preferred are 3-amino-1,2 propandiol and diethanolamine with boiling points of 262° C. and 217° C., respectively. At processing temperatures of 100° C.-160° C., volatility of these compounds is essentially negligible. As a consequence, they exhibit fluidic stability in the processing temperature range of interest for antigen retrieval. Moreover, retrieval can be affected in as short as only a few minutes at 120° C. And, no complex instrumentation is necessary to contain or manage or replenish fluid because the fluid is inherently stable within this temperature regime. In addition, the high temperature of the fluid melts the wax so that the fluid may contact the tissue to affect antigen retrieval without a prior separate de-wax operation. In a preferred embodiment of the invention, heating stations may be used that are pre-set to fixed temperatures wherein slides may be brought into contact for rapid temperature equilibration. As a result, heat up and cool down times associated with heater re-equilibration as was necessary with the prior art largely may be avoided resulting in faster slide processing. And once processed, slides wetted with low vapor pressure fluids in accordance with the present invention can sit for long periods of time before next operations without risk of tissue dry-out.

The present invention also relates to methods and apparatus for antigen retrieval and tissue conditioning using low or no vapor pressure liquid chemistry as above described.

### BRIEF DESCRIPTION OF THE DRAWINGS

Further features and advantages of the present invention will be seen from the following detailed description, taken in conjunction with the accompanying drawings, wherein:

FIG. 1 is a block diagram of an apparatus useful in practicing the present invention;

FIGS. 2-4 are graphs illustrating antigen retrieval in accordance with the present invention; and

FIGS. 5A and 5B are views similar to FIG. 1 of alternative forms of apparatus useful in practicing the present invention.

### DETAILED DESCRIPTION OF THE INVENTION

The present invention provides methods, materials and apparatus for antigen retrieval/tissue conditioning (used interchangeably throughout) which overcome the aforesaid and other disadvantages of the prior art. More particularly, the present invention is based on the use of antigen retrieval/tissue conditioning materials that exhibit low volatility at elevated temperatures, i.e., liquid materials exhibiting little or no vapor pressure at temperatures of about 1100° C.-160° C. or higher.

More particularly, the present invention permits tissue conditioning at 100-160° C. or higher by employing as on-slide conditioning fluids that have boiling points well above slide conditioning temperatures of 100-160° C. In one preferred embodiment the tissue conditioning fluid comprises an organic solvent that is liquid at room temperature, but has a boiling point in excess of about 200° C. In another preferred embodiment of the invention, the tissue conditioning fluid comprises an organic salt that is normally liquid at room temperature, and has a boiling point in excess of about 200° C.

The material used as a tissue conditioning fluid in the present invention should be liquid at room temperature, and have a boiling point at standard (one) atmosphere pressure in excess of about 200° C. The tissue conditioning fluid also should be compatible with chemicals used for staining, hybridization, etc., and capable of permitting the separation of paraffin used for embedding biological specimens. And, while the tissue conditioning fluid also should be capable of antigen retrieving the tissue specimens, it should have little or no other effect, i.e., morphological damage, to the tissue specimens.

The tissue conditioning fluid of the present invention serves the purposes of protecting the tissue samples from drying out and antigen retrieving the specimen at temperatures above paraffin's melting point of about 60° C. The tissue conditioning fluid allows the paraffin to float and separate at temperatures above paraffin's melting point of about 60° C.

The preferred tissue conditioning fluids of the present invention include aminoglycols and organic salts, i.e., a salt containing an organic ion. Particularly preferred organic salts useful in accordance with the present invention include organic borates such as 1-butyl-4-methylpyridium tetrafluoroborate, organic sulfates such as 1-butyl-3-methylimidazolium 2 (2-methoxy ethoxy)ethyl sulfate, and organic phosphates, which are normally liquid at room temperature and have a boiling point in excess of about 200° C. Preferred aminoglycols include 3-amino-1,2-propanediol; diethanolamine and triethanolamine.

The material used as tissue conditioning fluids in accordance with the present invention may be used undiluted. However, in order to reduce viscosity of certain materials, e.g., so that the material may be easily pumped and dispensed, the material may be diluted with water or an organic solution. However, if diluted, the material should comprise the principal component, typically about 5 to about 75% by volume of the diluted solution. The material and diluent should be miscible or at least dissolve in one another within the proportions employed. Particularly preferred is 3-amino-1,2-propanediol diluted with de-ionized water to about 50% by volume.

Preferably, but not necessarily, the tissue conditioning fluid is preheated before being applied to the slide. Preheating the tissue conditioning fluid facilitates slide processing, and in the case of viscous fluids, also facilitates transport of the fluid. Preferably, but not necessarily, the surface(s) that receives the tissue conditioning fluid is preheated before fluid is applied and the slide contacted. The preheated surface may be used to preheat the fluid prior to slide contacting. As a result of preheating the heat-up and cool-down times associated with slide heater reequilibrium may be largely avoided permitting retrieval in a short time and faster slide processing. Slides are contacted with pre-equilibrated temperature surfaces or environments in place of driving the coupled slide plus slide temperature-controlled station back and forth between temperature equilibriums.

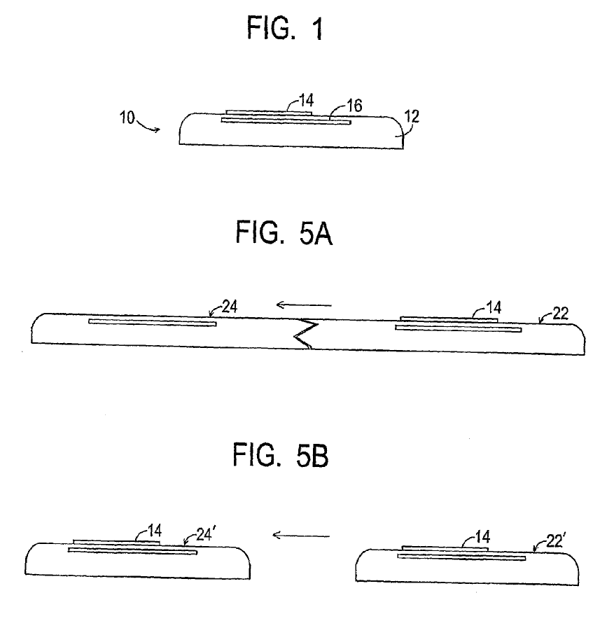

Referring to FIG. 1, the apparatus 10 comprises a slide holder 12 for supporting slides 14, and having slide heaters 16 designed to operate at elevated temperatures, i.e., 100-160° C.

The invention will be further described with reference to the following examples. In the following examples all automated examples are run on a DISCOVERY® autostainer available from Ventana Medical Systems, Inc., Tucson, Ariz., unless indicated as being manually run.

### EXAMPLE 1

### Ki67 on Tonsil on DISCOVERY® Autostainer Using Automated Antigen Retrieval

Tissue Block A was obtained containing a piece of paraffin embedded neutral buffered formalin fixed (unknown fixation time) tonsil of human origin. The block was micro-sectioned in approximately 4 micron thick sections, one section mounted per slide for a total of ˜200 slides provided for testing. Tissue cross section diameter was approximately 1.0 cm. Slides had sat in storage for a minimum of ˜1 month and so were effectively dried and adhered to the glass. Slides were de-waxed off-line in xylenes and graded alcohols with de-ionized water as the final fluid condition of the tissue. Antigen Ki-67 was selected for testing retrieval characteristics because it is known to be masked by formalin fixation. Hematoxylin counterstain was selected to improve visualization of tissue morphology. The following reagents were all obtained from Ventana Medical Systems, Inc., Tucson, Ariz.: Antibody CONFIRM™ anti-Ki67 (K-2 clone) catalogue #790-29 10; DAB MAP™ Kit cat #760-124; Universal Secondary Antibody P/N 760-4205; Hematoxylin P/N 760-2021; Bluing Reagent P/N 760-2037. All slides were processed on a Ventana DISCOVER® autostainer according to standard or modified protocols performing automated de-wax plus antigen detection processes, except where otherwise noted.

Three (3) slides were run per protocol “A” on a Ventana DISCOVERY® autostainer wherein no tissue conditioning (antigen retrieval) processing was performed. Two (2) additional slides were run per protocol “B” wherein “standard” tissue conditioning was selected.

Without tissue conditioning, no antigen was detected; no staining other than the counterstain was observed on any of the slides from this group. With tissue conditioning, Ki-67 antigen was clearly observed on all slides associated with and around germinal centers, indicating the efficacy and necessity of the tissue conditioning process in the recovery of the masked antigen. The intensity of staining was classified as “Dark” or maximally stained. Standard tissue conditioning involves 37 operational steps consuming 72 minutes of processing time. Morphology between the two conditions looked essentially equivalent and is defined as “Good”. Over-retrieval of specimens is a well-known issue in this field wherein morphological damage results. Morphological damage is understood as tissue and/or cellular structural definition degradation and loss and can range from mild to severe.

### EXAMPLE 2

### Time Dependence of Antigen Retrieval

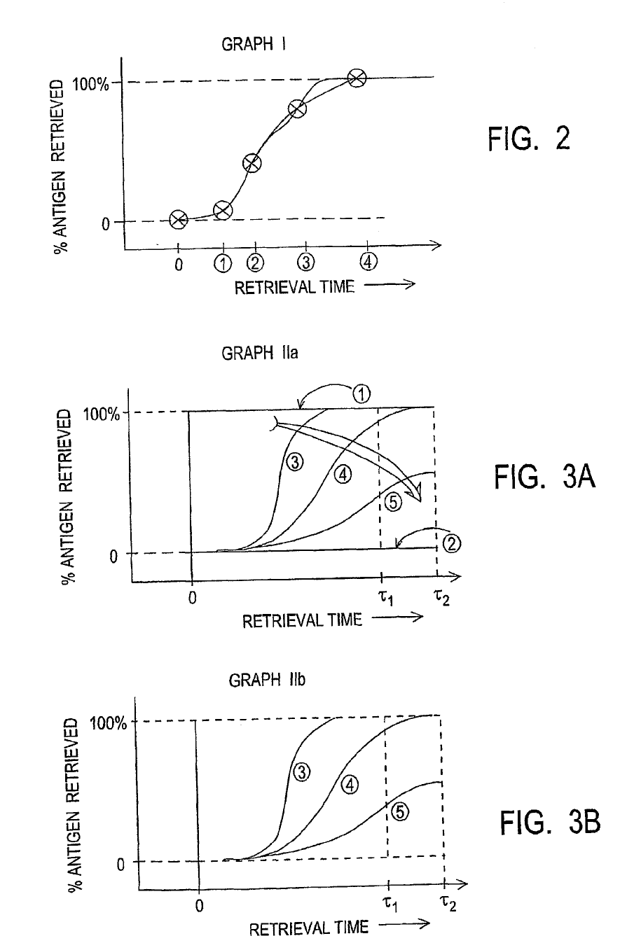

Tissue Block B was obtained containing a piece of paraffin embedded neutral buffered formalin fixed (unknown fixation time) human tonsil. Four (4) slides each with a single tissue section were run at various conditions of antigen retrieval processing with nominal set point processing temperature of 100 C: “Short”, “Mild”, “Standard”, and “Extended” protocols. All 4 protocols begin with the same heat ramp processing taking ˜18 minutes. Short tissue conditioning total time is 24 minutes; Mild is 42 minutes; Standard is 72 minutes; and Extended is 102 minutes, Each condition therefore progressively exposes the tissue sample to greater time of exposure to antigen retrieval processing. Table I illustrates the effect of retrieval time on observable stain intensity. It is evident that greater exposure time during antigen retrieval process increases the % antigens retrieved as measured by observable detection, illustrated in Graph I as shown in FIG. 2.

TABLE I

| Exposure Condition | Stain intensity |
|---|---|
| Short (24) min. | ~0 |
| Mild (42) min. | Light |
| Standard (72) min. | Medium |
| Extended (102) min. | Dark |

Block B demonstrates greater resistance to retrieval than Block A: Standard tissue conditioning process yielded Dark staining for Block A and only Medium staining for Block B. Graph IIa (FIG. 3a) illustrates this idealized relationship where Tissue Blocks A & B are represented by Curves 3 and 4, respectively. Curve 1 (FIG. 3a) represents the case where no retrieval is needed; the antigen is not masked and requires zero processing time before 100% of available antigen is available for detection. Curve 2 (FIG. 3a) represents the case where the antigen is irrecoverably masked, or alternatively, the retrieval process is simply not effective; retrieval processing fails to restore any antigenicity. Curves 3 through 5 (FIG. 3a) represent progressive degrees of recoverability resistance of the masked antigen. Greater retrieval processing is required for certain cases with respect to others, purportedly because of variances in the tissue preparative operations.

### EXAMPLE 3

### Temperature Dependence of Antigen Retrieval

Tissue Blocks B and C were obtained each containing a piece of paraffin embedded neutral buffered formalin fixed (unknown fixation time) tonsil of human origin. One slide each was stained using standard tissue conditioning and an additional slide was stained using the same protocol except that the tissue conditioning temperature was changed to 95° C. and 90° C. Results are reported in Table II:

TABLE II

| | Tissue C | Tissue B |
|---|---|---|
| Temperature | Stain Intensity | Stain Intensity |
| 100° C. | Dark | Medium |
| 95° C. | Dark | Light |
| 90° C. | Medium | Faint |

It is evident that Tissue B requires greater retrieval in order to recover an equivalent amount of antigen signal compared to Tissue C for each of the retrieval processes listed. Tissue morphology is good in all cases.

Three various antigen retrieval processes are illustrated in Table II differentiated by process temperature with various staining intensity results. Higher temperature provides greater antigen retrieval. Graph IIb (FIG. 3b) illustrates this temperature effect: Curve 3 represents the retrieval process at 100° C.; Curve 4 at 95° C.; Curve 5 at 90° C. Higher temperature provides more efficacious antigen retrieval for this chemistry without adverse morphological consequences. Curve 3 (FIG. 3b) represents a maximum efficiency curve for this given process because the aqueous tissue conditioning solution cannot be raised above its boiling point and remain in liquid phase. There are trade-offs, however, operating so near the maximum useable temperature. Protocol “B” illustrates the frequent fluid replenishing (12×) required to overcome fluid losses. For every replenishing, the operating slide volume temperature becomes depressed and requires time to recover. A large amount of fluid is consumed while producing a fair amount of fluid waste.

### EXAMPLE 4

### Chemical Conditioning Fluid Versus Water in Antigen Retrieval

Antigen retrieval chemistries vary in efficacy of retrieval. Various tissue conditioning fluids were tested under various exposure times using the same protocols and compared to Ventana Medical Systems, Inc. cell conditioning fluid (CC1) a citrate buffer, at 100° C. set point as a baseline. Two (2) slides each were stained using de-ionized water in place of CC1 at Mild and Extended conditions. The H₂O Mild condition stain intensity was equivalent to the Short CC1 condition; the Extended H₂O staining was equivalent to the Mild CC1 condition. Morphology was Good in all cases. Graph IIc (FIG. 3c) can be used to illustrate efficacy of retrieval processing based on specific chemistry. DI water as the antigen retrieval liquid is illustrated by Curve 5; CC1 chemistry by Curve 4. Preferred chemistries such as citrate buffer, therefore, accelerate the antigen retrieval process time, or alternatively, are more efficacious at retrieving antigen for otherwise equivalent processing conditions.

### EXAMPLE 5

### Low Vapor Pressure Antigen Retrieval Fluids at 100° C.

Chemistries of the present invention were explored for efficacy of antigen retrieval wherein candidate fluids were substituted in place of CC1. All candidates had in common low or no vapor pressure at 100° C. This attribute permitted simplification of protocols eliminating constant fluidic refreshments. Instead, a single bolus of fluid was administered at the outset of antigen retrieval processing followed by immediate temperature ramp up to 100° C. followed by a hold at temperature. The time it took to reach within about 2° of 100° C. was about 10 minutes in all cases. At the end of antigen retrieval processing, slide heaters were cooled in the conventional fashion followed by multiple rinses and detection processing.

For the several fluids tested, approximately 5 ul or just enough volume was used to completely cover a tissue section. The first fluid tested was dubbed “IL-1”: 1-butyl-3-methylimidazolium 2-(2-methoxyethoxy)ethyl sulfate, Chemika A.S., Bratislava, Switzerland, PIN #67421. The second fluid tested was “IL-2”: 1-butyl-4-methylpyridinium tetrafluoroborate, Chemika A.S., P/N73261. Three (3) slides were run per condition for IL-1 and 2 slides per condition for IL-2. A low vapor pressure aminoglycol compound was also assessed, “A-1”: 3-amino-1,2 propanediol, 97%, Sigma-Aldrich, Inc., St. Louis, Mo., PIN A76001. Two (2) slides were run for 38 minutes and 3 slides for 98 minutes. A larger volume of fluid, ˜20-50 ul was applied for the A-1 condition.

Prior to fluid application, slides were given a vigorous shake to remove the bulk of residual de-ionized water adhering to the slide surface post de-wax processing. A paper towel was used to blot excess droplets off of the glass surrounding the tissue section. Care was taken to avoid tissue dry-out during this procedure. Once the low vapor pressure antigen retrieval fluid was applied, the slide was rotated to accelerate and assure complete fluid coverage over the tissue section before the tissue had a chance to dry out. The slide was then placed onto a slide heater and protocol A was run. Results are summarized in Table III.

TABLE III

| | Stain | Stain | | Fluidic |
|---|---|---|---|---|
| Condition | Intensity | Uniformity | Morphology | stability |
| CC1 Mild (42:00) | Medium | Good | Good | Poor |
| CC1 Standard (72:00) | Dark | Good | Good | Poor |
| IL-1 (38:00) | Medium | Poor | Poor | Good |
| IL-1 (68:00) | Dark | Poor | Poor | Good |
| IL-2 (38:00) | 0 | N/A | Good | Good |
| IL-2 (68:00) | 0 | N/A | Good | Good |
| A-1 (38:00) | Faint | Good | Good | Good |
| A-1 (98:00) | Dark | Good | Fair | Good |

As is evident from the two IL-1 entries in Table III, IL-1 was efficacious at retrieving antigen, approximately equivalent to CC1 processing for similar time and temperature exposure conditions. However, morphology was degraded by the IL-1 treatment. Staining uniformity was also lacking; the pattern of non-uniformity was consistent between all IL-1 treated slides suggesting sensitivity to fixation artifact not seen in the CC1 conditions. IL-2 chemistry exhibited no retrieval efficacy under the present conditions. Tissue morphology was not affected by either treatment. A-1 chemistry at 38 minutes exhibited retrieval efficacy, though less than CC1 chemistry. The 98 minute treatment condition suggested “over-retrieval”; i.e., tissue morphology was degraded while the stain intensity was maximized. This result suggests that less treatment might not degrade the morphology as much while possibly still achieving (near) maximum stain intensity. Graph IV (FIG. 4) illustrates the relationship between % antigen retrieved and morphological degradation as a function of retrieval processing exposure. CC1 Standard processing is represented at time points T₁ and T₂ by Graph IV Curves 1a and 1b (FIG. 4). Stain intensity is maximized yet retrieval exposure is not so great as to cause morphological damage at these time points. However, if retrieval exposure was prolonged to time point T₃, morphological damage would be incurred. IL-1 processing is represented by Curves 2a and 2b (FIG. 4). Significant morphological damage is incurred before antigen is fully retrieved. Thus, some chemistries are preferred because they better provide antigen retrieval without causing corresponding excessive morphological damage.

Fluidic stability of the IL's and A-1 were all Good: fast time to temperature; no observable fuming or out-gassing/bubbles; no noticeable volume changes; +/−0.5° C. set point temperature maintenance compared to several degrees drop with fluid refreshments of CC 1 (as measured by the slide heater sensor).

### EXAMPLE 6

### High Temperature Low Vapor Pressure Antigen Retrieval Fluids

Specialized software was implemented on a DISCOVERY® instrument providing high temperature processing up to 120° C. True temperature (versus apparent) at the tissue surface is difficult to precisely assess; however, higher temperature, as indicated by the heater sensor, correlates to higher tissue surface temperature however imprecisely that may be known. While CC1 antigen retrieval chemistry is more efficacious than A-1 chemistry at ˜100° C. processing conditions (as demonstrated in Example 5), CC1 chemistry becomes impractical as temperature approaches the boiling point of solution resulting in serious fluidic instability issues, whereas low/no vapor pressure fluids do not suffer from this limitation. Further, processing at T>100° C. may be used to enhance efficacy of a particular chemistry.

Slides were obtained from Tissue Block C. Two (2) slides were processed per CC1, IL-2, and glycerol (99%, Sigma-Aldrich P/N G-5516) conditions using the methodology described in Example 5 per the details listed in Table IV. Glycerol was applied in excess in volumes of ˜50-100 ul. Two (2) slides were processed with A-1 low vapor pressure antigen retrieval fluid at 115° C. conditions; 4 slides each for the 12 and 16 minute 120° C. conditions using the methodology described in Example 5. The results are shown in Table IV. Both IL-2 and glycerol are not efficacious antigen retrieval chemistries at the current protocol settings as no staining was evidenced. Correspondingly, no degradation of morphology was observed. A-1 chemistry at T>100° C. demonstrated accelerated processing times for antigen retrieval in comparison to T=100° C. for CC1 processing. Further, fluidic stability is Good at elevated temperatures for A-1. At 16 minutes for A-1, stain intensity was maximized (Dark) with slight morphological degradation on one slide. At 12 minutes, one slide looked slightly under-retrieved (Medium stain). Since it takes ˜10 minutes for slide heaters to come up to set point temperature, short processing cycles of only slightly more than 10 minutes may be subject to temperature variance effects, unlike longer cycle processes where variances average out over time. Actual exposure time once at set point temperature may be quite short for effective retrieval, on the order of a few minutes at 120° C. for A-1. Fluidic stability was Good for all conditions using low/no vapor pressure fluids.

TABLE IV

| | | | | Stain | | |
|---|---|---|---|---|---|---|
| | | Time | Stain | Uni- | | Fluidic |
| Fluid | Temp | (min) | Intensity | formity | Morphology | stability |
| CC1 | 100° C. | 42 | Medium | Good | Good | Poor |
| CC1 | 100° C. | 72 | Dark | Good | Good | Poor |
| IL-2 | 120° C. | 38 | 0 | N/A | Good | Good |
| IL-2 | 120° C. | 68 | 0 | N/A | Good | Good |
| A-1 | 115° C. | 24 | Dark | Good | Good | Good |
| A-1 | 120° C. | 16 | Dark | Good | Good-Fair | Good |
| A-1 | 120° C. | 12 | Med-Dark | Good | Good | Good |
| Glycerol | 120° C. | 40 | 0 | Good | Good | Good |

### EXAMPLE 7

### A-2/A-3 High Temperature Antigen Retrieval

Two (2) other fluid compounds from the aminopolyol family were evaluated for efficacy of antigen retrieval using the methodology described in Example 5:triethanolamine (“A-2”: Sigma-Aldrich P/N T5830-0, bp=193° C.) and diethanolamine (“A-3”: Sigma-Aldrich P/N D8330-3, bp-217° C./150 mm Hg). Two (2) slides each from Tissue Block C were processed per condition, as listed in Table V. A-2 was not efficacious for retrieval under the present conditions. A-3 was efficacious, though not as efficacious as A-1 requiring greater processing to attain equivalent retrieval effect. A-1 at 120° C. for 20 minutes was over-retrieved exhibiting significant morphological damage. Results are summarized in Table V.

TABLE V

| | | Time | Stain | Stain | | Fluidic |
|---|---|---|---|---|---|---|
| Fluid | Temp | (min) | Intensity | Uniformity | Morphology | stability |
| A-1 | 120° C. | 20 | Dark | Good | Poor | Good |
| A-3 | 120° C. | 16 | Light | Fair | Good | Good |
| A-3 | 120° C. | 20 | Medium | Fair | Good | Good |
| A-3 | 120° C. | 24 | Dark | Good | Good | Good |
| A-2 | 120° C. | 16 | 0 | N/A | Good | Good |
| A-2 | 120° C. | 20 | 0 | N/A | Good | Good |
| A-2 | 120° C. | 24 | 0 | N/A | Good | Good |
| A-2 | 120° C. | 40 | 0 | N/A | Good | Good |

### EXAMPLE 8

### Free De-Wax Antigen Retrieval

Unlike the previous examples, slides were processed wherein no off-line de-wax pre-processing was performed. A volume of A-1 fluid (˜20-50 ul) was applied directly onto the center of the waxy tissue section on each slide. Because of the polar nature of the fluids and the non-polar nature of the paraffin sections, care was taken to ensure that the fluid drop was applied directly to the center region of the wax section fully covering the tissue. The relatively high viscosity of the A-1 fluid facilitated stability of the drop, as long as the application was well-centered. If the drop came too close to the waxy edge and touched any of the surrounding naked glass, surface tension forces were such that the polar fluid would flow off of the wax and become drawn out onto the glass surface leaving the tissue section uncovered and untreated. Fluidically, this is a highly unstable and impractical condition to operate under. Once slides were heated and the wax had melted, the applied fluids appeared to stabilize.

Nine (9) slides from Tissue Block A were obtained. Six (6) slides were de-wax processed off-line, as before, 3 were not. Of the 6 slides, 3 were left in 100% ethanol solution during de-waxing avoiding further solvent exchanging down to de-ionized water. Thus, immediately prior to antigen retrieval processing, 3 slides were de-waxed and hydrated, 3 were de-waxed and in 100% ETOH, and 3 were embedded in paraffin wax.

There was concern that upon cool down after antigen retrieval, the wax would re-solidify before there was a chance for it to be rinsed off of the slide. The protocol was adjusted such that slides were first cooled down to 75° C. wherein rinsing was performed. After one rinse cycle, the slides were allowed to cool down to ambient for further processing. All slides were retrieved at 120° C. for 20 minutes. All exhibited over-retrieval resulting in a “Poor” morphological score. Results are summarized in Table VI.

TABLE VI

| | Stain | Stain | | |
|---|---|---|---|---|
| State | Intensity | Uniformity | Morphology | Fluidic stability |
| H₂O | Dark | Good | Poor | Good |
| ETOH | Dark | Good | Poor | Good |
| WAX | Dark | Good | Poor | Poor |

Barring fluidic instabilities under the process of this example using the A-1 tissue conditioning fluid, the separate de-wax pre-processing operations can be eliminated thereby providing further accelerated processing. This may be called a “free de-wax” antigen retrieval process.

### EXAMPLE 9

### Free De-Wax Using IL-1, A-1 and A-3

Slides were processed at 120° C. using the free de-wax process described in Example 8 using ˜20-70 ul fluid volumes of IL-1, A-1, and A-3 fluids on slides from Tissue Block C. An additional 2 slides were retrieved with IL-1 where the slides had been previously off-linc dewax processed. The stain was significantly impacted in the IL-1 wax condition; only a few cells evidenced staining. Therefore, the presence of wax did impact the efficacy of the IL-1 retrieval whereas it did not for the A-1 and A-3. Results are summarized in Table VII.

TABLE VII

| | | | | Stain | Stain | |
|---|---|---|---|---|---|---|
| State | #slides | Fluid | Time | Intensity | Uniformity | Morphology |
| WAX | 2 | IL-1 | 16 | ~0 | N/A | Poor |
| H₂O | 2 | IL-1 | 16 | Medium | Good | Poor |
| WAX | 2 | A-1 | 14 | Dark | Good | Good |
| WAX | 3 | A-3 | 24 | Dark | Good | Good |

### EXAMPLE 10

### Solutions of A-1

The viscosity of the aminopolyols is sufficiently high to impede its ability to be pumped, e.g., through small diameter tubing. In the present example, A-1 was diluted with de-ionized water in order to reduce viscosity. Both 50% and 10% (v/v) concentrations of A-1 in water were formulated. Water and A-1 are both polar and miscible and mix together readily. Both the 50% and 10% formulations exhibited viscosities similar to that of water. Three (3) slides per condition (120 C) were processed using the free de-wax methodology described in Example 8 using ˜50-200 ul fluid volumes of 10% and 50% A-1 on slides from Tissue Block C. For the 10% condition, 200 ul volumes were applied, slides were treated for 12 minutes. For the 50% condition, ˜50-100 ul volumes were applied, slides were treated for 20 minutes. The lower viscosity facilitated fluid transport and fluid applications. However, the lower viscosity contributed to even higher fluidic instabilities; fluid more readily flowed and was more susceptible to migration off of the wax section and onto the surrounding glass regions. Greater care was required to ensure that retrieval fluid droplet stayed within the waxy section until the wax melted. Smaller volumes of retrieval fluid were less prone to migration; larger bodies were more prone to inertial and gravity effects that destabilized fluid positioning on slides.

Another effect of water addition was that slides took longer to come up to set point temperature of 120° C. as energy and time were required to vaporize the water content. No gas bubble formation was observed; slides were fluidically stable in this regard. Volumes changed, however, as water vaporized such that slides were not fluidically stable in this regard. The 10% formulations lost significant volumes through this process. Tissue was not uniformly covered with residual mixture which manifested as non-uniform staining. Where the tissue was covered by fluid, however, tissue stained Dark. Therefore, mixing A-1 with water was successful as a means to “thin” the retrieval fluid for fluid transport without impacting the efficacy of the retrieval chemistry. However, significant fluidic instabilities remain in regards to volatilization of the thinning water agent.

### EXAMPLE 11

### Membrane Fluidic Control

A 12″×25″ sheet of 0.002″ thick Kapton™ membrane (McMaster-Carr Supply Company, Los Angeles, Calif.: 12″×25″ P/N 2271K12) was cut into 2.5×5 cm size pieces. Several slides with waxy tissue sections from Tissue Block C were obtained. In the first case, a glass slide was presented with waxy tissue section face up and a 100 ul drop of de-ionized water applied. The water drop formed an unstable bead when applied to the waxy surface due to the non-polar nature of the wax in contrast to the polar nature of the fluid. Instability manifested as a tendency for the water drop to migrate and even in large measure fall off of the glass surface if the glass was moved or tilted. In the 2^{nd} case, a Kapton™ membrane piece was presented face up and a 100 ul drop of de-ionized water applied. The water drop adhered to the Kapton surface and resisted migration. The Kapton™ surface provided a more fluidically stable basis for capturing the fluid drop. Next, the glass slide was placed onto the drop of fluid from above with the waxy surface directly in contact. The fluid spread and completely covered the space between the membrane and glass as the two elements were brought into close contact. The presence of the non-polar waxy surface did not impede the coverage of fluid across the contacting region. The Kapton™ surface dominated and controlled the fluid dynamics, providing fluidic stability.

### EXAMPLE 12

### Fluidic Control and A-1 Antigen Retrieval

Nine (9) slides with waxy sections from Tissue Block C were treated to 120° C. 16:00 retrieval protocol using A-1 formulations. 200 ul of A-1 100% was applied carefully to the center tissue region of the waxy section on 3 slides. Another 3 slides received 200 ul of 100% A-1 and another 3 received 100 ul of 50% A-1. For these last 2 groups, a piece of Kapton™ was placed directly onto the slide immediately after A-1 fluid application (and prior to slide heat up) in order to provide complete coverage of the fluid across the dimensions of the slide. Upon completion of retrieval processing, membranes were removed during the cool down period to provide continued processing without membrane interference. The membranes, being thin and flexible, were curled when contacted with the fluid, which allowed for bubble-free fluid spreading between the two elements. Further, the membranes were curled during membrane release, which allowed for low stress removal of the wetted membranes. Upon contacting and release of the membranes, they spontaneously flattened out due to surface tensions thereby providing even distribution and coverage of fluid between the elements.

TABLE VIII

| | Mem- | Stain | Stain | | Fluidic |
|---|---|---|---|---|---|
| Condition | brane | Intensity | Uniformity | Morphology | Stability |
| 100% A-1 | No | Dark | Good | Good | Unstable |
| 100% A-1 | Yes | Dark | Good | Good | Stable |
| 50% A-1 | Yes | Dark | Good | Poor | Unstable |

Results (summarized in Table VIII) were indistinguishable between the membrane versus no membrane 100% A-1 cases. The membrane provided assurance of fluidic coverage across the surface of the glass slide regardless of non-polar regions. While the 50% case provided Good staining and uniformity results, it proved to be fluidically unstable. As the slides heated near H₂0 boiling, gas pockets formed beneath the membrane causing membrane “popping” motions. The resulting morphological damage was severe: much of the native tissue structure was disrupted presumably from localized gas pocket driven shear stress loading of the tissue. In the non-membrane (uncovered) cases of this Example and previous examples, water is free to volatilize unhindered and without associated effect on tissue morphology.

### EXAMPLE 13

### High Temperature Pre-Heating and Effect on Antigen Retrieval Time

When heating slides using the DISCOVERY® system for 14-20 minutes to affect antigen retrieval much of the process time (˜10 minutes) is associated with getting to set point temperature. If both the heater surface and the fluid drop were pre-heated thereby minimizing thermal lag effects during exposure, effective retrieval time could be significantly reduced. Two (2) slides per condition were obtained from Tissue Block C. Four (4) slides were off-line de-waxed and 4 slides were not. Several slide heaters (see FIG. 1) were programmed to stay at a constant temperature of 120° C. for a minimum of 10 minutes prior to use. All slide heaters were thoroughly cleaned with detergent followed by de-ionized water rinsing, prior to use. About 50-100 ul of A-1 fluid was applied directly to the pre-heated slide heaters and allowed an additional 30 seconds and 2 minutes to pre-heat the applied fluid. Slides were placed tissue surface face down into the pre-heated fluids, which spread providing coverage upon contacting. Slides were treated for either 4 or 6 minutes. Once treated, slides were removed from slide heaters, allowed to cool suspended in air for ˜10 seconds, upon which, they were placed tissue-side up onto pre-heated slide heaters at 75° C., where processing was completed through detection (reported in Table IX).

TABLE IX

| | | Stain | Stain | | Fluidic |
|---|---|---|---|---|---|
| State | Time | Intensity | Uniformity | Morphology | Stability |
| H₂O | 4 minutes | Dark | Good | Good | Stable |
| H₂O | 6 minutes | Dark | Good | Good | Stable |
| WAX | 4 minutes | Dark | Poor | Good | Stable |
| WAX | 6 minutes | Dark | Poor | Good | Stable |

The pre-de-waxed slides retrieved nicely at short exposure times to pre-heated retrieval chemistry demonstrating more expedient processing via minimization of thermal lag effects. The wax embedded slides exhibited non-uniform stain due to incomplete coverage. In previous examples, tissue was positioned such that the retrieval fluid is placed on top of the tissue. In the present case, the orientation is reversed the slide is inverted and tissue is placed down onto the pre-heated fluid. It appears that positioning impacts the ability of the retrieval fluid to gain access to the tissue when wax is present. Alternatively, with appropriately oriented apparatus, a heating element could be placed above the tissue sample providing appropriate staining results. Or, the slide with respect to the heating element could be reciprocated (agitated) in a back and forth motion to facilitate fluid access to tissue.

### EXAMPLE 14

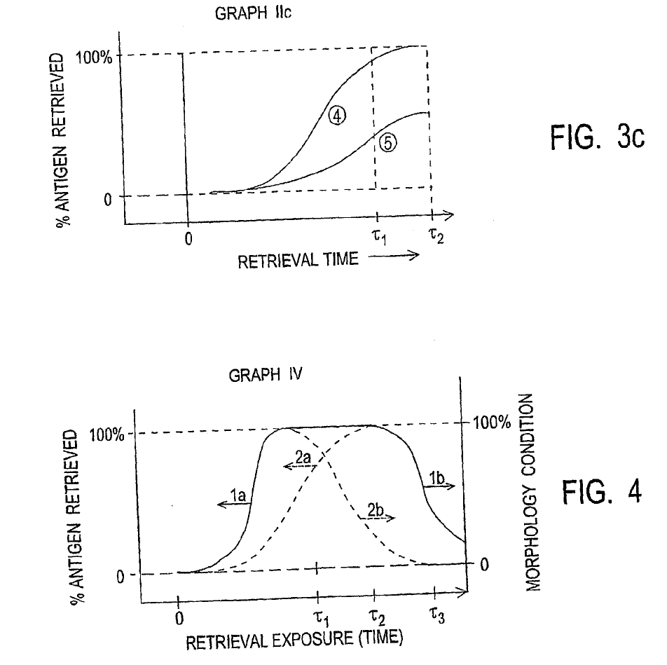

A first heater station fluid contacting surface (see FIG. 5A) is pre-heated to a set point temperature, e.g., 120° C. An antigen-retrieving fluid of the present invention (volume 100 ul) is applied to the first heater surface and a tissue mounted slide 14 is contacted with the fluid for rapid antigen retrieval treatment. Following treatment the slide 14 is removed from the first surface 22 and contacted with a second heated treatment surface 24 for subsequent treatment. The first and second treatment surfaces may be contiguous regions 22, 24 of the same system (FIG. 5A) component or alternatively may be discrete surfaces 22, 24 of separate heated surfaces (FIG. 5B). Alternatively, only a first treatment surface is used, e.g., for antigen retrieval wherein the retrieval fluid resists dry-out due to low vapor pressure thus not requiring immediate rinsing.

### EXAMPLE 15

### Ki67 on Breast on DISCOVERY® Autostainer Using Automated Antigen Retrieval

High temperature fluid antigen retrieval on human breast tissue was evaluated using the methodology described in Example 1. Tissue Block D was obtained containing a piece of paraffin embedded neutral buffered formalin fixed breast of human origin. The block was micro-sectioned in approximately 4 micron thick sections, one section mounted per slide. One slide each was stained following treatment with one of the following cell conditioning fluids: (1) 3-amino-1,2-propanediol diluted with de-ionized water to 50% concentration by volume; (2) concentrated high-temperature LIQUID COVERSLIP™ (LCS) which is a paraffinic hydrocarbon oil obtained from Ventana Medical Systems, Inc., Tucson, Ariz. (Catalog No. 650-010); and (3) LCS applied in a covering layer to the tissue bathed in EZ Prep, also available from Ventana Medical Systems, Inc. of Tucson, Ariz. (Catalog No. 950-102). The EZ Prep, which is sold as a 10× concentrate, was diluted 1:10 by volume with de-ionized water prior to use.

The slides were processed at 115° C. for various time periods prior to staining.

There was observed a significant loss of tissue in most cases, a problem common with collagenous loose connective tissue, particularly prevalent in breast tissue, and particularly so with aminopolyol processing. However, for that tissue that did adhere, excellent antigen retrieval was observed. Slides were held for 12, 16, 20 and 40 minutes at a temperature of 115° C. The results are reported in Table X.

TABLE X

| Conditioning Fluid | Stain Intensity | Stain Uniformity | Morphology |
|---|---|---|---|
| CC1 | Dark | Good | Poor |
| 3-amino- | Dark | Fair to Good | Good |
| 1,2propandiol | | | |
| LCS | Medium-Dark | Fair | Good |
| LCS + EZ Prep | Dark | Fair | Fair to Good |

Various changes may be made in the foregoing. For example, the fluid contacting surface may comprise a membrane in contact with a heater station. The membrane may be incremented with respect to the heater surface and/or the slide surfaces such that a fresh membrane surface is made available for each processed slide. Further, the processing station may be elongated such that a number of slides may be sequentially and simultaneously processed as they are conveyed down the length of the station. In such case, the slides may be continuously fed into the station, and, after an initial wait time to raise the temperature of the slides, the slides may be continuously processed through the station. Still yet other changes may be made without departing from the spirit and scope of the invention.

1: A method for preparing a biological sample on a slide for staining by contacting the sample with a fluid, wherein the fluid comprises a liquid material having a boiling point in excess of about 200° C., and heating the fluid material and/or sample sufficiently to antigen retrieve.

2: The method of claim 1, wherein the fluid comprises an aminoglycol.

3: The method of claim 2, wherein the aminoglycol is selected from the group consisting of 3-amino-1,2-propanediol, diethanolamine and triethanolamine.

4: The method of claim 1, wherein the fluid comprises an organic salt or ionic liquid.

5: The method of claim 4, wherein the organic salt is selected from the group consisting of an organic borate, an organic sulfate and an organic phosphate.

6: The method of claim 5, wherein the organic salt is selected from the group consisting of 1-butyl-3-methylimidazolium 2-(2-methoxyethoxy)ethyl sulfate and 1-butyl-4-methylpyridium tetrafluoroborate.

7: The method of claim 1, wherein the fluid is heated to a temperature in excess of 100° C.

8: The method of claim 7, wherein the fluid is heated to a temperature of 100° C.-160° C.

9: The method of claim 1, wherein the fluid is heated prior to being applied to the sample.

10: The method of claim 1, wherein the fluid is diluted prior to being applied to the sample.

11: The method of claim 10, wherein the diluent is added in minor amount.

12: The method of claim 1, wherein the fluid material includes a biological stain.

13: A biological sample conditioning fluid comprising a liquid material having a boiling point in excess of about 200° C., wherein said fluid material is capable of antigen retrieval.

14: The fluid of claim 13, wherein the liquid material comprises an aminoglycol.

15: The fluid of claim 14, wherein the aminoglycol is selected from the group consisting of 3-amino-1,2-propanediol, diethanolamine and triethanolamine.

16: The fluid of claim 13, wherein the liquid material comprises an organic salt or ionic liquid.

17: The fluid of claim 16, wherein the organic salt is selected from the group consisting of an organic borate, an organic sulfate and an organic phosphate.

18: The fluid of claim 17, wherein the organic salt is selected from the group consisting of 1-butyl-3-methylimidazolium 2-(2-methoxyethoxy)ethyl sulfate and 1-butyl-4-methylpyridium tetrafluoroborate.

19: The fluid of claim 13, wherein the liquid material is diluted in order to reduce its viscosity.

20: The fluid of claim 19, wherein the diluent is water or a high boiling point organic liquid which is miscible with the liquid material.

21: The fluid of claim 19, wherein the diluent is added in minor amount.

22: An apparatus for preparing a biological sample on a slide for staining by contacting the sample with a liquid material according to the method of claim 1, which comprises a reservoir for a liquid material capable of antigen retrieval, said liquid material having a boiling point in excess of about 200° C., and a dispenser for delivering a measured quantity of said fluid material to the slide.

23: The apparatus of claim 22, wherein the liquid material comprises an aminoglycol.

24: The apparatus of claim 23, wherein the aminoglycol is selected from the group consisting of 3-amino-1,2-propanediol, diethanolamine and triethanolamine.

25: The apparatus of claim 22, wherein the liquid material comprises an organic salt or ionic liquid.

26: The apparatus of claim 25, wherein the organic salt is selected from the group consisting of an organic borate, an organic sulfate and an organic phosphate.

27: The apparatus of claim 26, wherein the organic salt is selected from the group consisting of 1-butyl-3-methylimidazolium 2-(2-methoxyethoxy)ethyl sulfate and 1-butyl-4-methylpyridium tetrafluoroborate.

28: The apparatus of claim 22, further including a heater for heating the liquid material to a temperature in excess of 100° C.

29: The apparatus of claim 28, wherein the heater is adapted to heat the liquid material to a temperature of 100° C.-160° C.

30: The apparatus of claim 22, wherein the heater is adapted to heat the liquid material upstream of the dispenser.

31: The apparatus of claim 22, further including a heater for heating the slide to an elevated temperature in excess of about 100° C.

32: The apparatus of claim 31, wherein the heater is adapted to heat the slide to a temperature of 100° C.-160° C.
